(19) United States
(12) Patent Application Publication
(10) Pub. No.: US 2003/0163712 A1
(43) Pub. Date: Aug. 28, 2003

(54) Method & system for limiting use of embedded software

(76) Inventors: Brian P. LaMothe, Conrad, IA (US); David S. Willett, Conrad, IA (US); Irvin J. Schwartzenburg, Marshalltown, IA (US); Jesse R. Frederick, Nevada, IA (US)

Correspondence Address: CONLEY ROSE, P.C., P. O. BOX 3267, HOUSTON, TX, 77253-3267, US

(21) Appl. No.: 10/085,298

(22) Filed: Feb. 28, 2002

(51) Int. Cl. H04L 9/00

(52) U.S. Cl. 713/189

(57) ABSTRACT

The specification discloses a system and related method for limiting, or selectively authorizing, use of software in embedded microcontroller based systems. Licenses are provided on hardware keys, made up of serial EEPROMs, which may be moved from system to system and which may be also upgraded to increase the quantity or to change the expiration date of a licensed software program.

### CROSS-REFERENCE TO RELATED APPLICATIONS

This application is related to application Ser. No. ______ (Att'y Docket No. 1787-70700) titled “In-Place Dynamically Resizable Persistent Historical Database,” incorporated by reference herein as if reproduced in full below.

### STATEMENT REGARDING FEDERALLY SPONSORED RESEARCH OR DEVELOPMENT

Not applicable.

### BACKGROUND OF THE INVENTION

1. Field of the Invention

The preferred embodiments of the present invention are directed to limiting unauthorized use of software in embedded computing systems. More particularly, the preferred embodiments are directed to the use of a license key coupled to the embedded system which serves to authorize use of software within the embedded system.

2. Background of the Invention

Flow computers of the related art are microcontroller based systems. In order to implement the functionality of a flow computer, these microcontrollers execute software specifically designed to read external parameters, perform the flow calculations, and maintain historical databases of calculated volumetric flows. Flow computers have a wide variety of applications which may comprise calculating natural gas flow, steam flow, water flow, air or other gaseous substance flow, and the like. A particular vendor may create software to perform specialty calculations, which software may execute in hardware created by a different manufacturer. The software, for example a steam flow calculation program or natural gas flow calculation program, is simply placed on the ROM device and used by the microcontroller based system. However, within the context of embedded microcontrollers, there is no restriction in the related art on the use of software stored on the ROM devices. Thus, an end user can merely copy programs stored in the ROM of one microcontroller based system to a second ROM in a second device, making the program available in both devices, without the knowledge or consent of the vendor.

Thus, what is needed in the art is a mechanism to limit, or selectively allow, the use of software in embedded microcontroller based systems.

### BRIEF SUMMARY OF SOME OF THE PREFERRED EMBODIMENTS

The problems noted above are solved in large part by a physical license key and corresponding licensing method which allows an equipment manufacturer to selectively license use of software in an embedded microcontroller system. The physical key is a non-volatile memory, preferably a serial electrically erasable programmable read only memory (serial EEPROM) accessible to the microcontroller by way of a Serial Peripheral Interface (SPI) bus. The license key preferably holds data regarding which software programs may be executed on the particular system as well as related criteria: for example, the number of instances a particular software program may be executed on the system, an expiration date for a license software program, a license version number. Preferably software programs, whether produced by the original equipment manufacturer or a third party, check for the presence of a valid license on the license key prior to full execution of the functionality embodied in the software program.

The preferred embodiments also have the capability of splitting the licenses on a license key to create a second license key. For example, a single license key may provide authorization for execution of multiple instances of a particular software program, called a quantity. An end user may split the licensed quantity between two license keys. Conversely, an end user may need to merge various license keys to produce a single key, and this functionality too is included in the preferred embodiments. Thus, the preferred embodiments of the present invention address the problems of limiting, or selectively allowing, use of software in embedded microcontroller systems, while also giving the end user the capability of managing, as necessary, the software licenses.

The disclosed devices and methods comprise a combination of features and advantages which enable it to overcome the deficiencies of the prior art devices. The various characteristics described above, as well as other features, will be readily apparent to those skilled in the art upon reading the following detailed description, and by referring to the accompanying drawings.

### BRIEF DESCRIPTION OF THE DRAWINGS

For a detailed description of the preferred embodiments of the invention, reference will now be made to the accompanying drawings in which:

FIG. 1 shows, in block diagram form, the various components of the microcontroller based integrated control system of the preferred embodiments;

FIG. 2 shows, in block diagram form, the relationship between the operating system and various software components of the preferred embodiments;

FIG. 3A shows, in a simplified block diagram form, the information stored on a license key of the preferred embodiment;

FIG. 3B shows an exemplary key entry;

FIG. 4 shows an exemplary flow diagram of the steps to create a key entry on a license key;

FIG. 5 shows an exemplary flow diagram for reading key entry information from a license key;

FIG. 6 shows an exemplary screen shot of the license manager user interface of the preferred embodiments; and

FIG. 7 shows an exemplary flow diagram of the steps for upgrading a license key.

### NOTATION AND NOMENCLATURE

Certain terms are used throughout the following description and claims to refer to particular system components. This document does not intend to distinguish between components that differ in name but not function.

In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION OF THE PREFERRED EMBODIMENTS

The preferred embodiments are directed to a system and related method for licensing use of software in embedded microcontroller systems. In particular, the preferred embodiments were developed in the context of microcontroller based control systems having integrated functionality of a flow computer (to perform the volumetric flow calculation and historical database management), a programmable logic controller (PLC) to perform operations on discrete inputs and outputs), and a remote terminal unit. Because the preferred embodiments were developed in this context, the detailed description of the preferred embodiments below is also described in this context; however, the description of the preferred embodiments in this manner should not be construed as a limitation as to the applicability of the system and related methods described herein. The system and related methods, in a broad sense, find applicability in any embedded microcontroller or microprocessor based system, whether related to control systems or otherwise.

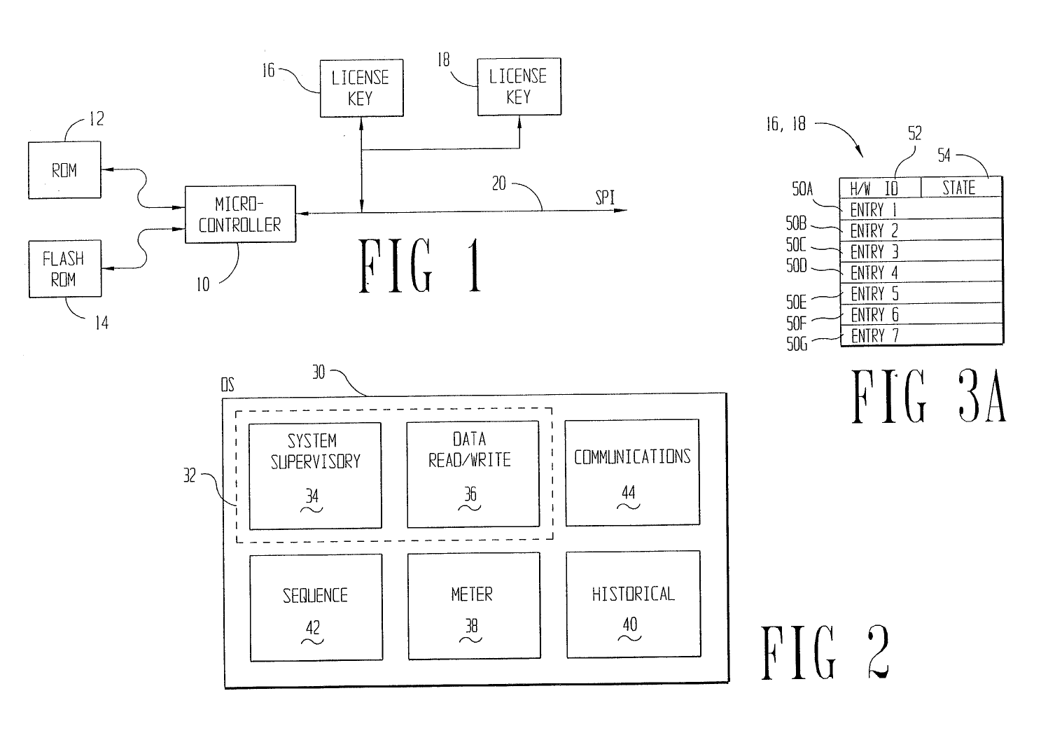

The preferred embodiments of the present invention are implemented in the context of an integrated process control system having the functionality of a flow computer, RTU and PLC in a single device. As it relates to the preferred embodiments of this invention, FIG. 1 shows, in block diagram form, the various components of the microcontroller based system of the preferred embodiments.

The heart of the embedded system is the microcontroller 10. In the preferred embodiments, the microcontroller 10 is a Motorola® MPC862SR. As one of ordinary skill in the art is aware, microcontrollers generally contain a core area as well as various additional hardware functionality such as analog-to-digital converters, onboard random access memory, universal asynchronous receiver transmitters (UARTs) for serial communication, and the like. While the Motorola® MPC862SR is the preferred microcontroller, one of ordinary skill in the art, once understanding the requirements of the particular system, could equivalently implement a system with other microcontrollers or microprocessors. A read only memory (ROM) 12 preferably couples to the microcontroller 10. The ROM 12 preferably stores the low level operating system for the microcontroller, as well as software programs that may be necessary to update the FLASHROM 14. Preferably the FLASHROM 14 is the semi-permanent storage location for software programs that are executed by the microcontroller 10 that implement the combined functionality.

ROM devices generally provide non-volatile storage, meaning that if power is lost, the information contained on the ROM remains intact. FLASHROM 14, however, in addition to have the standard ROM functionality, also has the ability to be written such that new programs for execution by the microcontroller 10 may be added. In the context of the combined flow computer, PLC and RTU functionality of the preferred embodiments, the FLASHROM 14 preferably contains software programs executable by the microcontroller 10 that implement the desired functionality. While FLASHROM 14 is preferred, any non-volatile storage device may be used to store the software programs. FIG. 1 also shows two license keys 16 and 18 coupled to the microcontroller 10 by way of the Serial Peripheral Interface (SPI) bus 20. The need to limit use of software on the FLASHROM 14 using key entries from the license keys 16, 18 stems from the preferred method of making the integrated process control system.

The integrated process control system is preferably shipped from the manufacturer with most, if not all, available software stored on the ROM 12 and FLASHROM 14. Some of the software provided with the integrated process control system will be operable on every device, for example the operating system stored on ROM 12. Portions of the software may implement functionality in the integrated process control system that is only selectively licensed to the end user by use of the license keys.

FIG. 2 shows, in block diagram form, the relationship between the operating system and various software components of the preferred system. The operating system 30 of the preferred embodiments is an OSE real-time operating system produced by OSE Systems, a subsidiary of Enea Group of Stockholm, Sweden. The OSE operating system package is a fault-tolerant software kernel specifically designed to take advantage of protected memory modes implemented in microcontrollers such as the Motorola® MPC862SR, which gives the integrated control system its fault tolerant and stable operation characteristics. The combination of the system supervisory software component 34 and the data read/write software component 36 may be collectively referred to as the input/output (I/O) interface components 32. The I/O interface components 32 are responsible for interfacing other software components to hardware of the system, such as I/O devices (not shown). Other specific software components implement the combined functionality, comprising a flow computer (software components 38 and 40), a PLC (software components 42) and an RTU (software component 44). The system supervisory software component 34 is responsible for accessing encrypted information on the serial EPROMs. Other software programs that need, or are required, to access the information on the license keys 16, 18 preferably request the information from the system supervisory component 34.

The preferred embodiments of the present invention have the capability to implement multiple stages of software licensing. Some software may be licensed for use by every user of the embedded system. Other software may be only selectively licensed. Yet other software may be licensed only to a certain extent—such as only a particular version of the software, up to a particular quantity of instances of the software running on the system, or until an expiration date. The PLC software component 42 is in the first category; namely, in the preferred embodiments the PLC software component 42 is included on the FLASHROM 14 but is only selectively licensed. Once licensed however, all the functionality of the PLC software component 42 is accessible to the user. Thus, prior to operation, the PLC software component 42 preferably accesses the system supervisory component 34 to verify whether licenses for use exist.

Other software programs of the preferred embodiments may require multiple instances (multiple copies executed on the microcontroller). For example, the meter software component 38 is responsible for spawning a sufficient number of metering software programs to perform calculations required for the multiple meter runs coupled to the integrated process control system. Thus, meter run software exemplifies a category of software components stored on the FLASHROM 14 which may be licensed for a particular number of instances (maximum quantity). Prior to spawning or starting multiple instances of the meter run software, the meter run component 38 preferably accesses the license key information, by way of the system supervisory component 34, to verify that a sufficient quantity of meter run programs are licensed for use. If more instances of meter run software are required than are licensed, the meter run software component 38 preferably only spawns up to the number licensed.

The license keys 16, 18 of the preferred embodiments are serial electrically erasable programmable read-only memories (serial EEPROMs). Many semiconductor manufacturers make serial EEPROM devices, however, the serial EEPROM Part No. 25LC040-I produced by Microchip Technology Incorporated is preferred. While it is possible to read and write to Serial EEPROMs over an Inter-Integrated circuit (I²C) bus, and other serial communication pathways, in the preferred embodiments the license keys are accessed by way of the SPI bus 20. Further, while serial EEPROMs are preferred, any non-volatile memory may be modified to perform the license key service. The serial EEPROMs are preferably off-the-shelf devices—it is the information stored on the devices, and the way the information is used, that implements the licensing scheme of the preferred embodiments.

FIG. 3A shows, in simplified block diagram form, the information stored on the serial EEPROM 16, 18 of the preferred embodiments. Before proceeding, it must be understood that the block diagram of FIG. 3A is not meant to be a representation of the physical placement of the information on the serial EEPROM; rather, the figure merely represents the preferred pieces of information stored on the serial EEPROM. One of ordinary skill in the art, after reading and understanding the discussion below, could easily devise many organizational structures for storing the information. Preferably each license key is capable of storing up to seven key entries 50A-G. Each key entry, in general terms, identifies the software program that it licenses, and if applicable, a quantity of licenses, an expiration date, and a licensed version. Further, each license key 16, 18 also comprises a hardware ID 52 and state entry 54. The hardware ID 52 and state 54 have a role in performing upgrades to the license keys, which is discussed more fully below. Before proceeding, it should also be noted that in the preferred embodiments, the information on the license keys 16, 18 is stored in an encrypted format.

FIG. 3B shows an exemplary key entry 50. In particular, the key entry 50 may comprise an application name 56, a version 58, a quantity 60, an expiration date 62, a provider name 63, a provider number 64, and a cyclic redundancy check section 66. The application name 56 preferably identifies the software program that the end user is licensed to use. The version 58 identifies which version of the application (identified in block 56) that the end user is licensed to use (if applicable). Thus, multiple versions of a software package may be shipped, and the end user is only licensed to use one of those software packages. The quantity 60, if applicable to the particular situation, identifies the number of instances a particular software application may be used.

Still referring to FIG. 3B, the key entry 50 may also comprise an expiration date block 62. In some circumstances, it may be desirable to license software to an end user for a certain amount of time, for example in a beta-test situation. The license key entry expiration date 62 preferably identifies the day when the license expires. As is discussed below, the licensing system provides protection for third party software, and the provider name 63 plays a role in the protection. The final two entries in the key entry 50 are the provider number 64 and cyclic redundancy check (CRC) 66. Preferably, both the provider number 64 and CRC 66 are hidden from view by the end user. That is, the end user may, through an embedded software package called a license manager, view the application name 56, version 58, quantity 60, expiration date 62 information and provider name 63, but preferably is not able to read the provider number 64 or the CRC information 66.

Because serial EEPROMs are, by their very nature, accessed in a serial nature, the greater the size of stored information, the longer it takes to read or write the information. The hardware ID 52 (FIG. 3A), state 54, and various key entries 50A-G are preferably sized to be as small as possible, while still providing sufficient byte widths for the necessary information. Knowing the precise number of bytes that each block contains is not critical for understanding, making, or use of the particular invention, and thus need not be discussed in great detail. However, the application name 56 and provider name 63 may require many bytes, while the version 58 and quantity 60 may require only a byte or two. Likewise, the expiration date 62 and provider number 64 may only require a few bytes to hold or impart the required information. The state 54 plays a role in providing upgrades for license keys, as discussed more fully below.

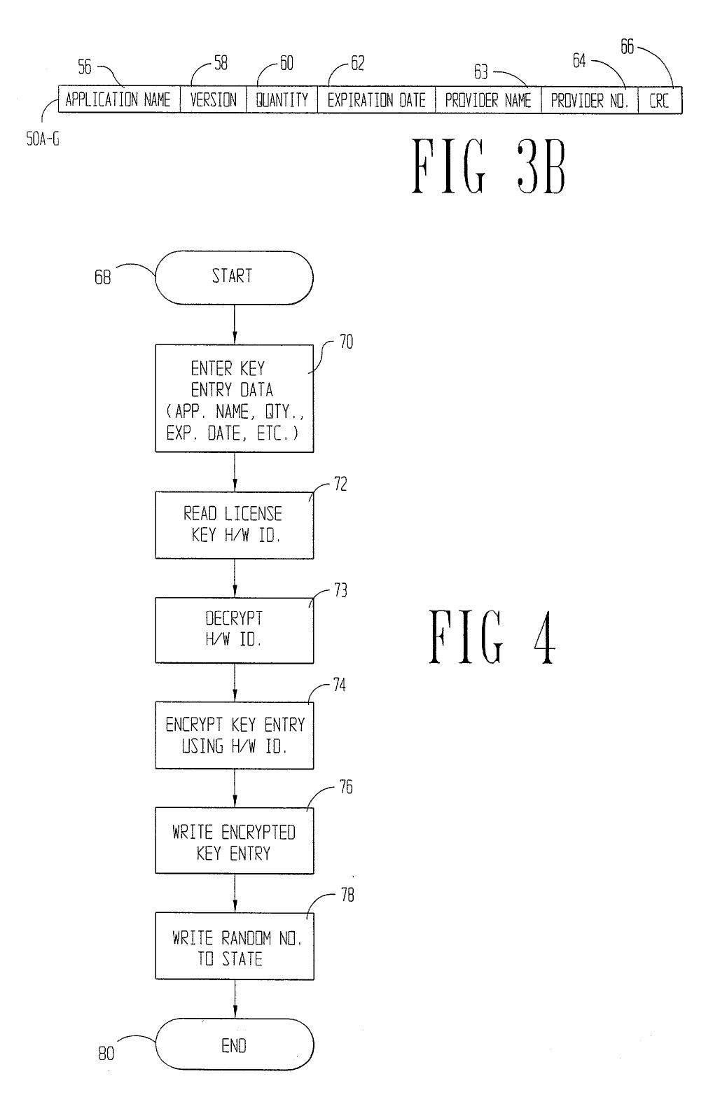

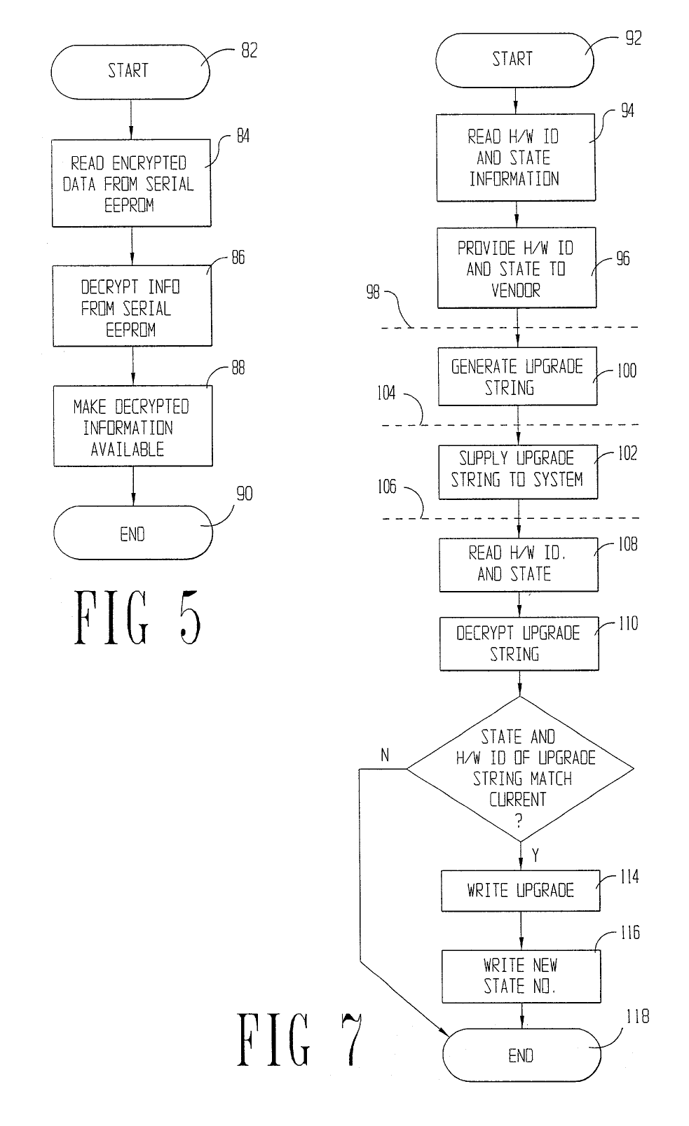

FIG. 4 shows an exemplary flow diagram of the steps to create a key entry on a license key 16, 18. In particular, the process starts at block 68, and the first component is providing key entry information (step 70). The key entry information preferably comprises the information exemplified in FIG. 3B. Once the key entry data has been provided, the next step is to read and decrypt the hardware ID 52 from the serial EEPROM 16, 18 (step 72). The hardware ID 52 is preferably a number that uniquely identifies the particular serial EEPROM 16, 18. Once the key entry data and hardware ID 52 are known, preferably the key entry data is encrypted using the hardware ID (step 74), and the encrypted information written to the serial EEPROM (step 76). Finally, in the preferred embodiments, each time a serial EEPROM is written, the state 54 is updated with a random number. Thus, the final step in creating an initial key on a serial EEPROM is the writing of a random number to the state block 54 (step 78) and the process ends (step 80). The importance of the state block 54 will be highlighted with regard to updating of key entry information, for example changing a quantity, expiration date or version by manual entry of strings of information, as discussed more fully below.

The system supervisory component 34 (FIG. 2) is responsible for accessing the SPI bus 20 and reading physical information from the license key 16, 18. Having now discussed the contents generally of a license key 16, 18, as well as placing a key entry 50A-G on the license key 16, 18, a similar discussion follows with respect to reading of license information by the system supervisory component 34. FIG. 5 shows an exemplary flow diagram for reading of the information by the system supervisory software 34. The process starts at block 82 and has as a first step reading of the encrypted data from the serial EEPROM (step 84). Next, the encrypted information is decrypted (step 86) and made available to other software programs (step 88) and the process ends. While encrypting the key entries and hardware ID on the license keys is preferred, no particular encryption scheme is more preferred, and any available encryption system may be used. While in the preferred embodiments the key entry data is encrypted using the hardware ID 52 as an encryption string, this need not necessarily be the case. Further, the length of the encrypted information may be shorter, the same, or longer than the original information, and all these variations would be within the contemplation of this invention.

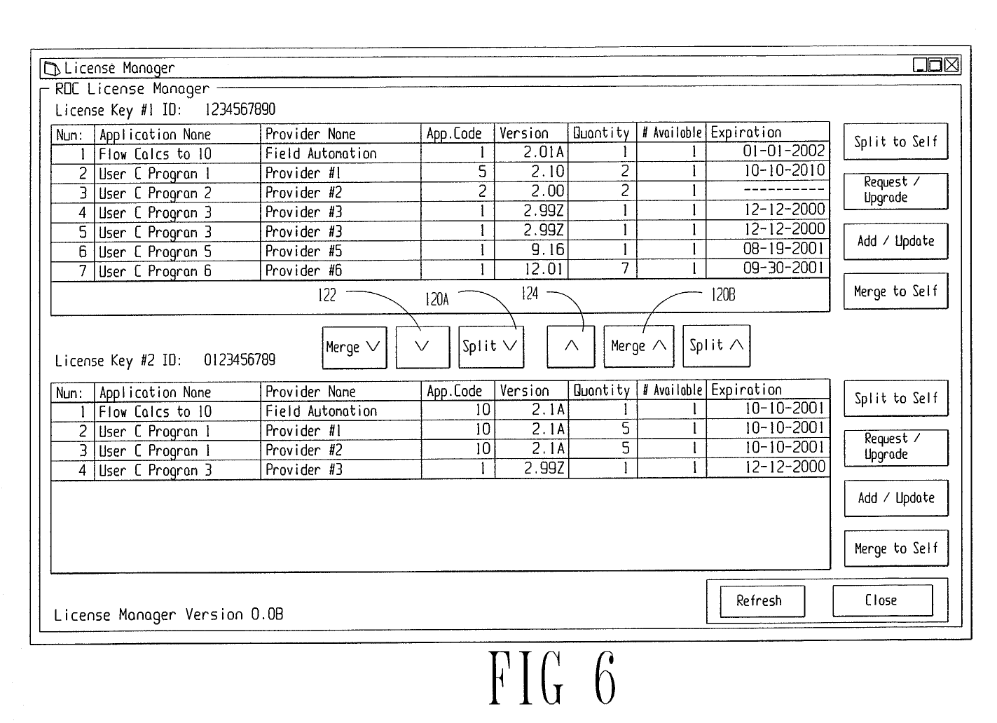

FIG. 6 shows an exemplary screen shot of a license manager user interface which exemplifies many of the features of the preferred embodiment. In particular, the screen shot of FIG. 6 shows an exemplary set of contents of both license keys 16, 18. For example, the section titled “License # 1 ID” may describe the contents contained on the license key 16. Likewise, the section titled “License # 2 ID” may describe the contents on the license key 18. FIG. 6 also exemplifies some of the features possible when using the preferred system and related method for licensing the embedded software. In particular, the split quantity buttons 120A, B exemplify that for key entries where many instances are licensed for use, it is possible to split the quantity into multiple key entries, and then to move the key entries from license key to license key. Buttons 122 and 124 exemplify that in the preferred embodiment it is possible to transfer licenses from license key to license key, for example from license key 16 to license key 18, or vice versa.

Because of the licensing system of the preferred embodiments, the integrated control systems may be shipped with all available software at the time of manufacture, and only portions of the software licensed in the manner described. However, the end user may need to upgrade—whether to add additional quantities, to seek a license for a program not previously licensed, or to change a license expiration date. The preferred embodiments enable an end user to upgrade to have the ability to use additional software by supplying to the end user a string of information which may add licenses, change versions, increase quantities, or extend expiration dates.

FIG. 7 shows a flow diagram exemplifying the steps of upgrading a license key to include a new software license, or to upgrade an existing license. The process starts at step 92 and proceeds immediately to a reading of the hardware ID 52 and state 54 (step 94). In order to generate a new upgrade string of the preferred embodiment, as discussed more fully below, both the hardware ID and the state information need to be known by the vendor. Thus, step 94 exemplifies that the end user needs to first read the hardware ID and state information, preferably using a license manager software embedded in the integrated control system (the license manager decrypts the hardware ID prior to providing the information), and provide the hardware ID and state number to the vendor (step 96). The steps above dashed line 98 are accomplished by the end user, to some extent aided by the license manager software and graphical user interface thereto. The vendor, whether the original equipment manufacturer or a third party generating software for use on the embedded system, generates the upgrade string (step 100) using the hardware ID and state information provided by the end user (steps 94, 96). The upgrade string preferably contains, in encrypted form, the hardware ID 52 and the state 54 of the serial EEPROM to be modified, as well as the new key entry information. The vendor supplies the upgrade string to the end user, who preferably enters the upgrade string in the embedded system (step 102), such as through a keypad. The upgrade string is decrypted by the license manager (step 110), and compared to the hardware ID and state read in step 108 (comparison at step 112). If the hardware ID and the state of the upgrade string do not match the serial EEPROM, the process simply ends (step 118). Thus, the upgrade string is only applicable to a particular serial EEPROM having a particular state. If, however, the hardware ID and the state of the upgrade string match that of the license key 16, 18, the upgrade is preferably written to the license key (step 114). Finally, after each write to a serial EEPROM the state 54 is preferably rewritten to contain a new random number, as indicated at step 116. Writing a new random number to the state 54 ensures that the upgrade string may only be used a single time. The upgrade string may be delivered to the end user in any suitable fashion such as by post office mail, by electronic-mailing the string, facsimile, generation over a web-based system, or even dictating the upgrade string to the end user over the telephone.

When describing the key entries 50A-G with respect to FIG. 3B, it was mentioned that a portion of the key entry 50A-G may be a provider name 63 and provider number 64. In the somewhat open architecture systems of embedded microcontrollers, it is possible that third parties may write software to execute on the hardware of another provider. The preferred embodiments of the present invention allow third party vendors to protect their proprietary software using the methods and system described. In order for a provider to have this ability, however, there needs to be a mechanism for the provider to license use of the software created. If a third party provider creates a software program for execution on the embedded microcontroller, the provider enables the software to verify the existence, quantity, expiration date, etc., of a key entry 50A-G on a license key 16, 18 by reading the information from the system supervisory component 34 as previously described. However, the third party manufacturer also needs the capability to provide new licenses, as well as providing upgrades to existing licenses, similar to that described with respect to FIG. 7. The provider name 63 and number 64 are provided to ensure that each third party provider may create licenses only for their products.

Each third party manufacturer will be provided by the integrated control system manufacturer a non-embedded software program which enables them to generate upgrade strings and license keys. Preferably, each non-embedded software program given to a manufacturer has hard-coded therein a provider number which is based, at least in part, on the provider name. Each key entry or upgrade string generated by the third party manufacturer inherently includes the provider name and number. Preferably, each software program checking for proper licensing (by communication with the system supervisory component 34) also checks the provider number 64 to ensure that the license was generated by an entity authorized to do so. In the case where a key entry 50A-G already exists and the end user is merely upgrading using an upgrade string, the provider number is embedded within the encrypted upgrade string. Thus, before applying an upgrade to an existing key entry 50A-G, the license manager software embedded in the microcontroller verifies that the provider number of the key entry 50A-G to be upgraded matches that of the provider number that generated the upgrade string and that the provider number is sufficiently related to the provider name. Each third party manufacturer does not have the ability, in the software provided to them for generating license keys and upgrade strings, to change their provider number. In this way, the third party manufacturers are not able to generate license keys for software generated by other manufacturers.

In normal operation, the integrated control system of the preferred embodiment powers on and goes through a boot sequence. At some point thereafter, the various software components 34, 36, 38, 40, 42 and 44 are loaded as required by the particular system. During the boot sequence, but preferably prior to any of the software components spawning underlying tasks, the system supervisory component 34 accesses the SPI bus 20 and reads information from the license keys 16, 18, if present. The system supervisory component 34 then decrypts the information contained on the one or more license keys 16, 18 (see FIG. 5), and thereafter that information is available to other software components and tasks. With regard to the sequence component 42, which is preferably licensed in an on/off fashion, the sequence component 42 preferably accesses license information from the system supervisory component 34 to ascertain whether the sequence functionality is enabled for the particular unit. If not licensed, the functionality is not provided to the end user. With regard to the meter component 38, prior to spawning tasks thereunder to perform the volumetric flow calculations, the meter component 38 preferably accesses license information from the system supervisory component 34 to determine the quantity of meter components that are licensed for the particular unit. Preferably, the meter component 38 spawns only up to the number of licensed instances of the meter functionality. Similarly, the communications component checks for proper licensing.

Next, consider the situation where an integrated control system is in operation and the end user wishes to upgrade licensing. With regard to licensing previously unlicensed software (but which software is present on the system ROM as installed during manufacture), the end user, preferably by way of the license manager embedded in the integrated control system, accesses the hardware ID 52 and current state 54 of the license key to be upgraded. The hardware ID 52 and state 53 are then provided to the original equipment manufacturer or third party provider. The original equipment manufacturer or third party provider then combines the upgraded key entry, hardware ID, and existing state information, encrypts the information, and provides the upgrade string to the end user. Providing the upgrade string to the end user may take many forms, for example, sending the upgrade string by regular mail, by electronic mail, by facsimile, web-based generation and delivery, or by simply telling the end user the upgrade string over some type of voice communication. Thereafter, the end user enters the upgrade string into the license manager software embedded on the integrated control system which decrypts the information. Thus, the license manager has at its disposal the proposed upgrade string, the hardware ID and state of the license key on the system, and the hardware ID and state of the device to which the upgrade is supposed to be applied. If either of the hardware ID or the state of the upgrade string do not match the hardware and state of the license key, then the upgrade is not performed. Thus, the upgrades may not be applied to different license keys. Further, since the state portion of each license key is written with a new random number each time the serial EEPROM is written, an upgrade string may be used only one time, even for the correct license key.

In the case where the upgrade string looks to upgrade an existing key entry (as opposed to becoming a new key entry), the license manager software embedded in the integrated control system also, in addition to the steps from the paragraph immediately above, preferably verifies that the provider name and number in the proposed upgrade string matches the provider name and number in the key entry to be modified, thus ensuring that manufacturers may only provide upgrades for licenses to their products.

As was discussed with respect to FIG. 6, the preferred embodiments have the ability to split and merge license key entries, as well as shifting the license key entries from license key to license key. Consider, for example, an end user who has many integrated control systems distributed throughout a chemical processing plant performing various tasks. Further consider that the end user wishes to upgrade the functionality of all the devices with regard to quantity of a licensed product. In such a circumstance, the original equipment manufacturer or third party vendor may supply only a single upgrade string with a large quantity value. After upgrading the license key specifically identified by the hardware ID and state of the upgrade string, the user may thereafter, from the upgraded string, split the license key as to quantity and distribute the quantity about many physical license keys. In this way, only a single upgrade string, in combination with some leg work, would provide an end user with the capability of upgrading every integrated control system in this example.

The above discussion is meant to be illustrative of the principles and various embodiments of the present invention. Numerous variations and modifications will become apparent to those skilled in the art once the above disclosure is fully appreciated. For example, the preferred embodiments of the present invention are described to use a Motorola® MPC862SR microcontroller; however, one of ordinary skill in the art, now understanding the integrated control system of the preferred embodiments and how the license key 16, 18 play into limited use of existing software, could easily identify many microcontrollers and microprocessors that would be applicable in such a system. Further, the licensing method and system disclosed herein mentions only that some information is encrypted or decrypted. As one of ordinary skill in the art is aware, there are numerous encryption and decryption methods disclosed and available on the market, and any of these could be equivalently used in the system. It is intended that the following claims be interpreted to embrace all such variations and modifications.

What is claimed is:

1. In an embedded microcontroller based control system comprising a microcontroller having the ability to execute programs stored on a first non-volatile storage device, the embedded microcontroller based control system also having a second non-volatile storage device coupled to the microcontroller, a method comprising:
accessing a key entry stored on the second non-volatile storage device, the key entry identifying programs on the first non-volatile storage device licensed for execution on the microcontroller; and
limiting use of the programs stored on the first non-volatile storage device based on the key entry on the second non-volatile storage device.

2. The method as defined in claim 1 wherein limiting use of the programs stored on the first non-volatile storage device based on the key entry on the second non-volatile storage device further comprises limiting a number of instances of use of a first software program stored on the first non-volatile storage device.

3. The method as defined in claim 1 wherein limiting use of the programs stored on the first non-volatile storage device based on the key entry on the second non-volatile storage device further comprises limiting use of a set of software programs stored on the first non-volatile storage device to a version number identified in the key entry, where the set of software programs are distinguished by version number.

4. The method as defined in claim 1 wherein limiting use of the programs stored on the first non-volatile storage device based on the key entry on the second non-volatile storage device further comprises limiting use of a first software program after an expiration date identified in the key entry.

5. The method as defined in claim 1 wherein accessing a key entry stored on the second non-volatile storage device further comprises reading the key entry from the second non-volatile storage device across an interface bus.

6. The method as defined in claim 5 wherein second non-volatile storage device further comprises a read only memory (ROM) device.

7. The method as defined in claim 6 wherein reading the key entry from the ROM device across an interface bus further comprises reading a serial electrically erasable programmable read only memory (serial EEPROM) across a Serial Peripheral Interface (SPI) bus.

8. A system for selectively allowing use of embedded comprising:
a microcontroller;
a first non-volatile storage device coupled to the microcontroller, the first non-volatile storage device storing a plurality of programs executable by the microcontroller, the plurality of programs comprising at least a program to perform flow calculations, a program to perform PLC functions, and a program to perform RTU functions;
a second non-volatile storage device coupled to the microcontroller by way of an interface bus, the second non-volatile storage device storing software license information; and
wherein the microcontroller is adapted to refrain from executing at least one of the plurality of programs on the first non-volatile storage device if the software license information on the second non-volatile storage device does not contain an entry allowing use.

9. The system as defined in claim 8 wherein the second non-volatile storage device further comprises a read only memory (ROM) device.

10. The system as defined in claim 9 wherein the interface bus further comprises a serial interface bus.

11. The system as defined in claim 10 wherein the ROM device further comprises a serial electrically erasable programmable read only memory (serial EEPROM).

12. The system as defined in claim 10 wherein the serial interface bus further comprises a Serial Peripheral Interface (SPI) bus.

13. The system as defined in claim 12 wherein the serial EEPROM further comprises a part number 25LC040-I device manufactured by Microchip Technology Incorporated.

14. The system as defined in claim 10 wherein the serial interface bus further comprises an Inter-Integrated Circuit (I²C) bus.

15. The system as defined in claim 8 wherein the second ROM device further comprises a flash ROM device.

16. A gas flow measurement computer comprising:
a microcontroller;
a non-volatile storage device coupled to the microcontroller, the non-volatile storage device storing a gas flow measurement software program executable by the microcontroller;
a read only memory (ROM) device coupled to the microcontroller by way of an interface bus, the ROM device storing a string of bytes that indicate a number of instances the gas flow measurement software program that may run on the microcontroller; and
wherein the microcontroller accesses the string of bytes on the ROM device and limits the number of instances of the gas flow measurement software program to the number indicated in the string of bytes.

17. The gas flow measurement computer as defined in claim 16 wherein the microcontroller further comprises a Motorola® microcontroller model number MPC862SR.

18. The gas flow measurement computer as defined in claim 16 wherein the interface bus further comprises a serial interface bus.

19. The gas flow measurement computer as defined in claim 18 wherein the ROM device further comprises a serial electrically erasable programmable read only memory (serial EEPROM).

20. The gas flow measurement computer as defined in claim 19 wherein the serial interface bus further comprises a Serial Peripheral Interface (SPI) bus.

21. The gas flow measurement computer as defined in claim 20 wherein the serial EEPROM further comprises a model number 25LC040-I manufactured by Microchip Technology Incorporated.

22. The gas flow measurement computer as defined in claim 16 wherein the non-volatile storage device further comprises a read only memory device.

23. A method of manufacturing an integrated functionality control system comprising:
manufacturing an embedded microcontroller based control system comprising a microcontroller, a non-volatile storage device coupled to the microcontroller, and an interface bus coupled to the microcontroller;
loading a plurality of software programs on the non-volatile storage device at the time of manufacture of the embedded microcontroller based control system;
coupling a license key to the interface bus, the license key containing software licensing information; and
allowing, selectively, use of the plurality of software programs based on the software licensing information.

24. The method of manufacturing an integrated functionality control system as defined in claim 23 wherein loading a plurality of software programs on the non-volatile storage device at the time of manufacture of the embedded microcontroller based control system further comprises:
loading a volumetric gas flow calculation program;
loading a sequence logic implementation program; and
loading a communications program.

25. The method of manufacturing an integrated functionality control system as defined in claim 24 wherein allowing, selectively, use of the plurality of software programs based on the software licensing information further comprises allowing up to a specified quantity, based on the licensing information on the license key, of instances of the volumetric gas flow calculation program executing on the microcontroller.

26. The method of manufacturing an integrated functionality control system as defined in claim 24 wherein allowing, selectively, use of the plurality of software programs based on the software licensing information further comprises allowing the sequence logic implementation program to execute fully if authorized by the licensing information on the license key.

27. The method of manufacturing an integrated functionality control system as defined in claim 24 wherein allowing, selectively, use of the plurality of software programs based on the software licensing information further comprises allowing the communications program to execute fully if authorized by the licensing information on the license key.

28. A method of managing software licensing on an embedded microcontroller based system comprising:
coupling a first license key, having a key entry, to a microcontroller by way of an interface bus;
coupling a second license key, having a key entry, to the microcontroller by way of the interface bus;
limiting use of software on the embedded microcontroller based system based on the key entries of the first and second license keys; and
relocating one of the key entries to a different key.

29. The method of managing software licensing on an embedded microcontroller based system as defined in claim 28 wherein relocating one of the key entries to a different key further comprises merging the key entry from the second license key with the key entry on the first license key.

30. The method of managing software licensing on an embedded microcontroller based system as defined in claim 29 wherein merging the key entry from the second license key with the key entry on the first license key further comprises merging the key entry, licensing a first quantity, of the first license key with the key entry, licensing a second quantity, of the second license key to be a single key entry on one of the first and second license keys.

31. The method of managing software licensing on an embedded microcontroller based system as defined in claim 28 wherein relocating one of the key entries to a different key further comprises splitting the key entry from the first license key to reside partially on the first license key, and partially on the second license key.

32. The method of managing software licensing on an embedded microcontroller based system as defined in claim 31 wherein splitting the key entry from the first license key to reside partially on the first license key and partially on the second license key further comprises:
dividing a quantity of a key entry of the first license key; thereby
creating a first key entry on the first license key, and a second key entry on the first license key, each of the first and second key entries having a quantity; and
moving the second key entry to the second license key.

33. The method of managing software licensing on an embedded microcontroller based system as defined in claim 28 wherein coupling a first license key, having a key entry, to a microcontroller by way of an interface bus further comprises coupling a read only memory (ROM) device to the microcontroller.

34. The method of managing software licensing on an embedded microcontroller based system as defined in claim 33 wherein coupling a read only memory (ROM) device to the microcontroller further comprises coupling a serial electrically erasable programmable read only memory (serial EEPROM) to the microcontroller by way of the interface bus.

35. The method of managing software licensing on an embedded microcontroller based system as defined in claim 34 wherein coupling a serial electrically erasable programmable read only memory (serial EEPROM) to the microcontroller by way of the interface bus further comprises coupling the serial EEPROM to the microcontroller by way of a Serial Peripheral Interface (SPI) bus.

36. The method of managing software licensing on an embedded microcontroller based system as defined in claim 33 wherein coupling a second license key, having a key entry, to the microcontroller by way of the interface bus further comprises coupling a second serial electrically erasable programmable read only memory (serial EEPROM) to the microcontroller by way of the interface bus.

37. The method of managing software licensing on an embedded microcontroller based system as defined in claim 28 wherein limiting use of software on the embedded microcontroller based system based on the key entries of the first and second license keys further comprises limiting a number of instances of use of a first software program based on the key entries of the first and second license keys.

38. The method of managing software licensing on an embedded microcontroller based system as defined in claim 28 wherein limiting use of software on the embedded microcontroller based system based on the key entries of the first and second license keys further comprises limiting use of a set of software programs distinguished by version number to a version number identified in the key entries of the first and second license keys.

39. The method of managing software licensing on an embedded microcontroller based system as defined in claim 28 wherein limiting use of software on the embedded microcontroller based system based on the key entries of the first and second license keys further comprises limiting use of a first software program after an expiration date identified in one of the key entries of the first and second license keys.

40. A method comprising:
executing software programs on an embedding microcontroller based control system;
licensing use of the software programs by a non-volatile storage device coupled to the microcontroller, the microcontroller checking for software licenses on the non-volatile storage device before executing programs; and
upgrading the software licenses comprising:
entering an encrypted upgrade string into the embedded microcontroller based control system;
decrypting the upgrade string; and therewith
changing the software licenses on the non-volatile storage device.

41. The method as defined in claim 40 further comprising, before the entering the encrypted upgrade string step:
reading a parameter stored on the non-volatile storage device; and
providing the parameter stored on the non-volatile storage to an entity generating the upgrade string.

42. The method as defined in claim 41 wherein reading a parameter stored on the non-volatile storage device further comprises:
reading a hardware identification number stored on the non-volatile storage device; and
reading a state number stored on the non-volatile storage device.

43. The method as defined in claim 41 further comprising, between the decrypting step and the changing step, verifying that the parameter stored on the non-volatile storage device matches a corresponding parameter contained in the upgrade string.

44. The method as defined in claim 43 wherein changing the software licenses on the ROM device further comprises changing software licenses on the non-volatile storage device only if the parameter stored on the non-volatile storage device matches the corresponding parameter contained in the upgrade string.

45. The method as defined in claim 44 wherein reading a parameter stored on the non-volatile storage device further comprises:
reading a hardware identification number stored on the non-volatile storage device; and
reading a state number stored on the non-volatile storage device.

46. The method as defined in claim 45 wherein verifying that the parameter stored on the non-volatile storage device matches a corresponding parameter contained in the upgrade string further comprises:
verifying that the hardware identification number stored on the non-volatile storage device matches a corresponding hardware identification number contained in the upgrade string; and
verifying that the state number stored on the non-volatile storage device matches a corresponding state number contained in the upgrade string.

47. The method as defined in claim 46 further comprising, after the changing the software licenses on the non-volatile storage device step, writing a new state number to the non-volatile storage device.

48. A method of upgrading software licenses for software contained in embedded microcontroller based systems, the method comprising:
requiring a user of the embedded microcontroller based system to provide a parameter from a read only memory (ROM) device within the embedded microcontroller based system;
combining updated software license information with the parameter from the ROM device to produce an upgrade string;
sending the upgrading string to the user of the embedded microcontroller based system; and
having the end user enter the upgrade sting into the embedded microcontroller based system to upgrade software licenses.

49. The method as defined in claim 48 wherein combining updated software license information with the parameter from the ROM device to produce an upgrade string further comprises encrypting the updated software license information and the parameter from the ROM device.

50. The method as defined in claim 48 wherein sending the upgrading string to the user of the embedded microcontroller based system further comprises sending the upgrade string to the user by electronic mail.

51. The method as defined in claim 48 wherein sending the upgrading string to the user of the embedded microcontroller based system further comprises sending the upgrade string to the user by post office mail.

52. The method as defined in claim 48 wherein sending the upgrading string to the user of the embedded microcontroller based system further comprises sending the upgrade string to the user by facsimile.

53. The method as defined in claim 48 wherein sending the upgrading string to the user of the embedded microcontroller based system further comprises sending the upgrade string to the user by voice communications.

54. The method as defined in claim 48 wherein sending the upgrading string to the user of the embedded microcontroller based system further comprises sending the upgrade string to the user by web based generation and delivery.

55. The method as defined in claim 48 wherein requiring a user of the embedded microcontroller based system to provide a parameter from a ROM device within the embedded microcontroller based system further comprises requiring the user of the embedded microcontroller to provide a hardware identification number and state number from the ROM device.

56. The method as defined in claim 55 wherein combining updated software license information with the parameter from the ROM device to produce an upgrade string further comprises encrypting the updated software license information, the hardware identification number and the state number to produce the upgrade string.

57. The method as defined in claim 56 wherein sending the upgrading string to the user of the embedded microcontroller based system further comprises sending the upgrade string to the user by electronic mail.

58. The method as defined in claim 56 wherein sending the upgrading string to the user of the embedded microcontroller based system further comprises sending the upgrade string to the user by post office mail.

59. The method as defined in claim 56 wherein sending the upgrading string to the user of the embedded microcontroller based system further comprises sending the upgrade string to the user by facsimile.

60. The method as defined in claim 56 wherein sending the upgrading string to the user of the embedded microcontroller based system further comprises sending the upgrade string to the user by voice communications.

61. The method as defined in claim 56 wherein sending the upgrading string to the user of the embedded microcontroller based system further comprises sending the upgrade string to the user by web based generation and delivery.
